(19) United States
(12) Patent Application Publication
(10) Pub. No.: US 2019/0308160 A1
(43) Pub. Date: Oct. 10, 2019

(54) METHOD FOR DEPOSITING A CATALYST ON THE INNER SURFACE OF THE MICROCHANNELS OF A REACTOR-EXCHANGER

(71) Applicants: L'Air Liquide, Societe Anonyme pour I'Etude et I'E, Paris (FR); Centre National de la Recherche Scientifique, Paris (FR)

(72) Inventors: Baptiste CROISSANT, Limoges (FR); Raphael FAURE, Saint Remy les Chevreuse (FR); Romain JOLY, Epinay sur Orge (FR); Fabrice ROSSIGNOL, Verneuil sur Vienne (FR)

(21) Appl. No.: 16/315,027

(22) PCT Filed: Jul. 3, 2017
(86) PCT No.: PCT/FR2017/051789

§ 371 Date: Jan. 3, 2019

(30) Foreign Application Priority Data
Jul. 5, 2016 (FR) 1656425

(51) Int. Cl. B01J 19/00; B01J 37/02

(52) U.S. Cl. CPC B01J 19/0093; B01J 37/0215; B01J 2219/00835; B01J 2219/00862; B01J 2219/0079; B01J 2219/00891

(57) ABSTRACT

A process for the deposition of a catalyst in an exchanger-reactor including an inlet, an outlet, and microchannels, the microchannels including an internal surface, the process including positioning the exchanger-reactor in a vertical position, wherein the inlet and the outlet are in a plane perpendicular to a horizontal plane and, wherein the inlet and outlet are below the microchannels, introducing a catalyst in suspension into the exchanger-reactor via the inlet by means of a pump, filling the exchanger-reactor with the catalyst in suspension at a rate of between 5 and 20 ml/min, and emptying the exchanger-reactor, thereby depositing at least a portion of the catalyst on the internal surface.

### CROSS REFERENCE TO RELATED APPLICATIONS

This application is a 371 of International PCT Application PCT/FR2017/051789, filed Jul. 3, 2017, which claims priority to French Patent Application No. 1656425, filed Jul. 5, 2016, the entire contents of which are incorporated herein by reference.

### BACKGROUND

The present invention relates to a process for the deposition of a catalyst in the millimetric channels of an exchanger-reactor.

Currently, the most widespread process for the production of synthesis gas is the steam reforming of methane. This reaction is catalytic and endothermic. The heat necessary for the reaction is obtained by combustion in a radiation furnace. The synthesis gas is thus obtained at high temperature (in the vicinity of 900° C.). An already widespread optimization provides for the reaction to take place in a millistructured exchanger-reactor in order to improve the heat and material transfers within the reactor.

### SUMMARY

A process for the deposition of a catalyst in an exchanger-reactor including an inlet, an outlet, and microchannels, the microchannels including an internal surface, the process including positioning the exchanger-reactor in a vertical position, wherein the inlet and the outlet are in a plane perpendicular to a horizontal plane and, wherein the inlet and outlet are below the microchannels, introducing a catalyst in suspension into the exchanger-reactor via the inlet by means of a pump, filling the exchanger-reactor with the catalyst in suspension at a rate of between 5 and 20 ml/min, and emptying the exchanger-reactor, thereby depositing at least a portion of the catalyst on the internal surface.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates a schematic representation in accordance with one embodiment of the present invention.

FIG. 2 illustrates another schematic representation in accordance with one embodiment of the present invention; and

FIG. 3 illustrates another schematic representation in accordance with one embodiment of the present invention.

### DESCRIPTION OF PREFERRED EMBODIMENTS

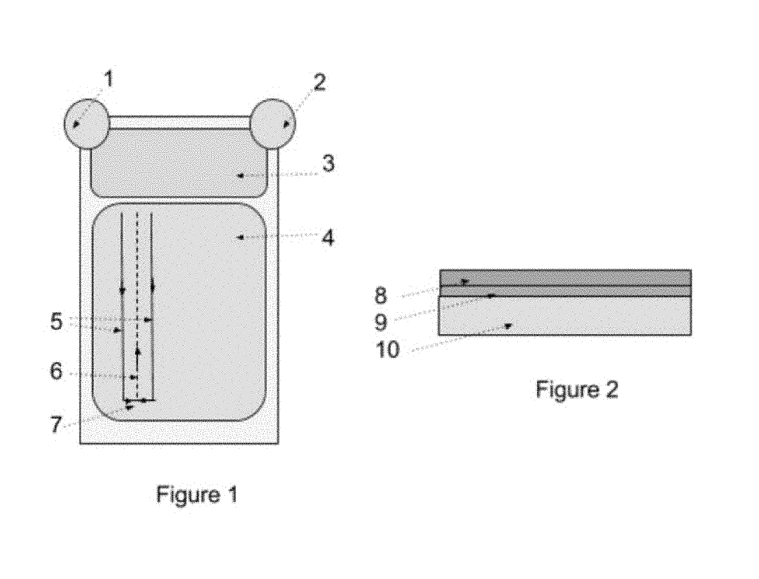

The reforming reactor with which this invention is concerned is a one-piece assembly, consisting of different parts, represented by FIGS. 1 and 2. The term “one-piece reactor” is understood to mean a reactor not exhibiting an assembling interface. The inlet and the outlet 2 of the exchanger-reactor are directly connected to the distribution zone 3, which feeds the exchange zone 4. The exchange zone 4 consists of straight and parallel channels: among these straight channels, the reactive channels 5, the product channels 6 and the junctions 7 between two reactive channels 5 and a product channel are distinguished. The term “millimetric channel” is understood to mean a channel of millimetric dimensions. The term “reactive channels” is understood to mean the millimetric channels where a catalytic reaction takes place and the term “product channels” is understood to mean the millimetric channels which make possible the circulation of the product stream. Only the inlet 1, the distribution zone 3 and the reactive channels 6 are coated with a catalyst 8. In addition to the deposit of catalyst 8, these channels can also be coated with a coating which protects against corrosion 9 applied to the surface 10 of the reactive channels.

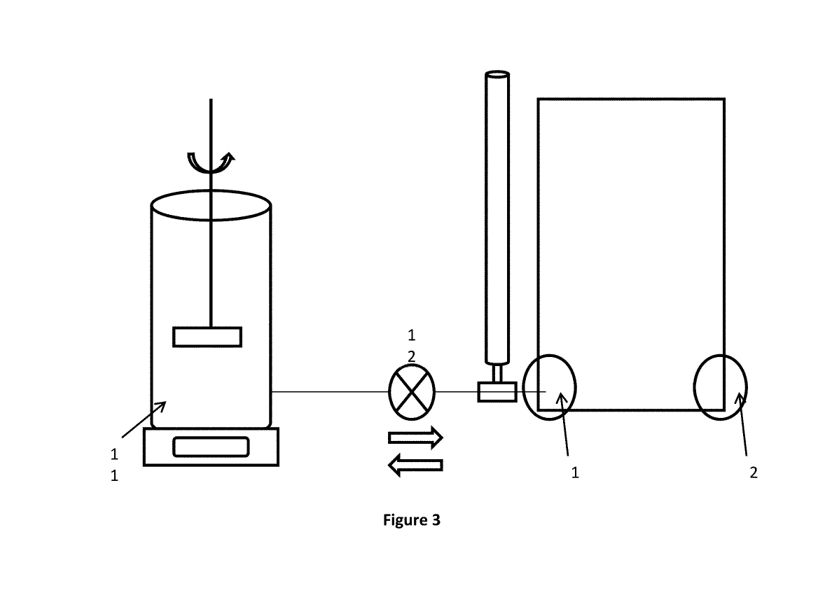

The reactor itself is represented in FIG. 3. The reactor is a closed assembly, the reactive channels of which are accessible solely via the inlet 1 and the outlet 2.

There exist several references in the literature which provide methods for the coating of catalysts on substrates of different natures. Valentini et al. (Catalysis Today, 2001) provide for the deposition of a boehmite-based bonding primer, before carrying out the deposition of catalyst or of γ-alumina. This method is applicable to open structures of foam or honeycomb types, made of ceramic or metal, in particular for the preparation of catalysts for catalytic combustion. More generally, numerous examples are found in the work by Cybulski and Moulijn, Structured Catalysts and Reactors, for application for automobile pollution control and three-way catalysis, for the purification of flue gases and the reduction of nitrogen oxides, or also for the removal of volatile organic compounds. Nevertheless, none of the examples mentioned exhibits a process which makes it possible to coat a reactor as presented in FIGS. 1 and 2 of the present invention. Furthermore, there exist very few examples describing procedures for coating the catalyst at the surface of the millimetric channels of reactors-exchangers. Very often, reactors-exchangers having millimetric channels are the result of the assembling by clamping of plates engraved and coated with catalyst beforehand. One alternative consists in coating beforehand substrates of foam, porous bar, metal grid or wave type, which are subsequently inserted into the millimetric channels of the reactors-exchangers.

However, currently, there does not exist a method for accurately depositing the catalyst in a reactor-exchanger having microchannels, according to FIGS. 1 and 2, in other words a preassembled reactor-exchanger, so that the catalyst suspension is deposited at the surface of the millimetric channels and while precisely controlling the length of millimetric channels coated and also the amount of catalyst deposited.

A solution of the present invention is a process for the deposition of a catalyst at the internal surface of the microchannels of an exchanger-reactor comprising the following stages:

i) installing the exchanger-reactor in the vertical position so that the inlet 1 and the outlet 2 of the exchanger-reactor are in a plane perpendicular to the horizontal plane and are in the bottom position, the microchannels being located above,

ii) introducing a catalytic suspension into the exchanger-reactor via the inlet 1 by means of a pump 12,

iii) filling the exchanger-reactor with the catalytic suspension at a rate of between 5 and 20 ml/min, and

iv) emptying the exchanger-reactor.

As the case may be, the process for deposition of the catalyst according to the invention may exhibit one or more of the following characteristics:
the exchanger-reactor does not exhibit assembling interfaces and comprises an inlet 1 and an outlet 2, a distribution zone 3 feeding an exchange zone 4 consisting of reactive channels 5, of product channels 6 and of junctions 7 between the reactive channels and the product channels, and the filling stage iii) is such that the catalytic suspension does not cross the junction 7 between the reactive channels and the product channels,
the filling of stage iii) is carried out until a level lower by at least 5 mm in the junction 7 between the reactive channels and the product channels is reached,
the pump 12 operates within a range of flow rates extending from 5 ml/min to 2500 ml/min. Preferably, the pump will make possible, for several sizes of exchanger-reactor, a rate of coating of the order of 0.5 cm/min during the filling and of the order of 100 cm/min during the emptying of the suspension.
the filling is controlled using a gauge,
the gauge is vertical and parallel to the exchanger-reactor,
the catalytic suspension is kept stirred throughout the deposition process,
said exchanger-reactor is manufactured as a single block by additive manufacturing,
the reactive channels 5 have a diameter of greater than or equal to 1.5 mm.

The process for the deposition of catalyst according to the invention is described in more detail using FIGS. 1 to 3.

The suspension is kept stirred 11 throughout the duration of the deposition procedure. This stirring can be carried out preferably by means of a magnetic stirrer.

The suspension is circulated as far as into the exchanger-reactor by the use of a pump 12 which can operate within a range of throughputs extending from 5 ml/min to 2500 ml/min. The use of a peristaltic pump is preferred here.

The suspension is introduced via the inlet 1 into the reactor-exchanger. The suspension is distributed successively from the inlet 1 to the distribution zone 3 and to the exchange zone 4, in order to make it possible to coat the reactive channels 5 without ever crossing the junction 7 between the reactive channels 5 and the product channels 6.

The level of filling of the exchanger-reactor is read on a level gauge positioned on a tee fitting attached to the inlet 1 of the exchanger-reactor. The gauge is vertical and parallel to the exchanger-reactor. The gauge consists of a material which is sufficiently transparent to allow direct reading of the height of the level. The material also has to be compatible with the solvent used in the catalyst suspension. The gauge has an internal diameter at least greater by a millimeter than the diameter of the reactive channels 5 and of the product channels 6, and it has to have a length greater by at least 2 cm than the length of the reactor channels 5.

The filling is carried out at a rate of between 5 and 20 ml/min, preferably less than 15 ml/min, in order to guarantee homogeneous filling of the microchannels 5 present in the exchange zone 4.

The filling of the reactive channels 5 is carried out until a level lower by at least 5 mm at the junction 7 is reached.

After filling, the exchanger-reactor is emptied in order to discharge the catalyst suspension from the inside of the reactive channels 5, from the exchange zone 4 and from the inlet 1. The emptying flow rate is controlled and has to make possible a rate of withdrawal of the suspension inside the reactive channels 5 of 10 to 20 mm/s.

The procedure described above can be used for reactive channels 5 with a diameter of greater than or equal to 1.5 mm.

The procedure described above can be automated by replacing the level gauge with a level sensor with control of the pump used to transport the catalyst suspension.

The procedure described above can be repeated several times if the thickness of the catalyst deposit produced in one pass is insufficient. In this case, the catalyst deposit has to be dried beforehand, preferably under a gentle stream of dry air or nitrogen, at a maximum flow rate of 2 l/min, for a period of time which depends on the nature of the solvent used for the preparation of the catalyst suspension.

The amount of catalyst deposited inside the exchanger-reactor is known by measuring the amount of suspension recovered during the emptying phase, the charge of catalyst powder of the suspension being known.

The process for the deposition of catalyst according to the invention makes it possible to coat with catalyst the microchannels of a preassembled reactor-exchanger, as is presented in FIGS. 1 and 2 of the present invention.

An example of the deposition process according to the invention is given below.

### Example

For an exchanger-reactor having 200 reactive channels with a diameter of 2 mm and with a length of 20 cm, i.e. a total volume of 125.7 ml, a catalyst suspension with a viscosity of equal to 4 mPa·s is available. The suspension is introduced into the exchanger-reactor at a flow rate of 10 ml/min and the filling level is monitored by reading the gauge placed at the inlet of the reactor and parallel to the reactor. Filling is carried out up to 5 mm from the junction between the reactive channels and the product channels. Immediately after having reached the filling threshold, the suspension is emptied at a flow rate of 0.63 ml/min. The amount of suspension recovered is weighed and indicates a deposition of 20 ml of suspension inside the exchanger-reactor; as the suspension is charged at 8 vol % of catalyst and the catalyst has a density of 4 g/ml, a weight of catalyst deposited during this first pass of approximately 6.4 g is deduced therefrom.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-9. (canceled)

10. A process for the deposition of a catalyst in an exchanger-reactor comprising an inlet, an outlet, and microchannels, the microchannels comprising an internal surface, the process comprising:
positioning the exchanger-reactor in a vertical position, wherein the inlet and the outlet are in a plane perpendicular to a horizontal plane and, wherein the inlet and outlet are below the microchannels,
introducing a catalyst in suspension into the exchanger-reactor via the inlet by means of a pump,
filling the exchanger-reactor with the catalyst in suspension at a rate of between 5 and 20 ml/min, and
emptying the exchanger-reactor, thereby depositing at least a portion of the catalyst on the internal surface.

11. The process of claim 10, wherein the exchanger-reactor does not exhibit assembling interfaces and further comprises:
a distribution zone feeding an exchange zone comprising reactive channels, product channels, and junctions between the reactive channels and the product channels, and
wherein during the filling, the catalyst in suspension does not cross the junction between the reactive channels and the product channels.

12. The process of claim 10, wherein the filling is carried out until a level lower by at least 5 mm than the junction between the reactive channels and the product channels is reached.

13. The process of claim 10, wherein the pump operates within a range of flow rates extending from 5 ml/min to 2500 ml/min.

14. The process of claim 10, wherein the filling is controlled using a gauge.

15. The process of claim 14, wherein the gauge is vertical and parallel to the exchanger-reactor.

16. The process of claim 10, wherein the catalyst in suspension is kept stirred throughout the deposition process.

17. The process of claim 10, wherein the exchanger-reactor is manufactured as a single block by additive manufacturing.

18. The process of claim 10, wherein the reactive channels have a diameter of greater than or equal to 1.5 mm.
